(19) United States
(12) Patent Application Publication
(10) Pub. No.: US 2007/0296210 A1
(43) Pub. Date: Dec. 27, 2007

(54) Universal joint

(75) Inventor: Wen-Chin Shu, Taipei (TW)

Correspondence Address: WPAT, PC;INTELLECTUAL PROPERTY ATTORNEYS, 2030 MAIN STREET, SUITE 1300, IRVINE, CA, 92614, US

(73) Assignee: WORLD FRIENDSHIP CO., LTD.

(21) Appl. No.: 11/473,317

(22) Filed: Jun. 23, 2006

(51) Int. Cl. F16L 27/04

(52) U.S. Cl. 285/261

(57) ABSTRACT

A universal joint having a screw cap, a rotating portion and a screw tube. The screw cap has a first stop portion located at one of openings, and a first seal pad is provided in an inner part of the screw cap. The rotating portion is comprised of a rotating head connecting to a pipe, the rotating head has a hole on a upper half-circle ball portion of the rotating head, and the half-circle ball portion is utilized to support the first stop portion of the screw cap. A second stop portion with external threading pattern is provided in the screw tube, wherein a second seal pad is provided on the second stop portion, the screw cap is sealed with the second stop portion. The hole of the rotating head is securely closed off and sealed off.

### BACKGROUND OF THE INVENTION

1. Field of Invention

The present invention relates to a universal joint that is connected to an air pipe of a compression pump and a pneumatic device. The present invention is comprised of a pneumatic device that can rotate in any direction without restriction from a connecting air pipe.

2. Description of the Related Art

Most of the equipment in the automatic production line uses air or oil compression as the output power and allows operators to disintegrate components easily in the production line. FIG. 1 shows a schematic view of a conventional rotating joint utilized in an air compression pump and a pneumatic device, while FIG. 2 shows a 3-D illustration of a conventional rotating joint.

For FIG. 2, air compression pump 1 is connected to an air pipe 11, wherein one free end of air pipe 11 is comprised of a valve joint 12 which is connected by various functions to pneumatic device 2. With a hollow cylinder shape, rotating head 21 is provided on the pneumatic device 2. Rotating portion 211 can be rotated via a handle provided on the rotating head 21. A screw tube 212 with external thread pattern on its surface is provided on one end of the rotating portion 211. Another end of the rotating portion 212 is comprised of a connecting tube 214 of a lock portion 213, wherein the screw tube 212 can be locked into a corresponding locking hole of the pneumatic device 2 via the rotating portion 211. The lock portion 213 of the connecting tube 214 can be utilized to lock the connecting tube 214 tightly within the valve joint 12 as shown in FIG. 1.

When the worker operates the pneumatic device 2 to disintegrate other devices, the operation angles of the pneumatic device 2 have to be adjusted according to various structures of the device. The end of the pneumatic device 2 utilizes the rotating head 21 to connect to the valve joint 12 of the air pipe 11 to form an upright connecting portion. Therefore, in a confined environment, the pneumatic device 2 cannot be angled in various directions as a result of the upright connecting portion. Thus, the conventional pneumatic device 2 cannot be used in an environment with limited space.

### SUMMARY OF THE INVENTION

The purpose of the present invention is to provide an improved pneumatic device that can be rotated in any direction without the restriction of connection to an air pipe. The present invention provides a universal joint comprising of a screw cap, a rotating portion and a screw tube. The screw cap has a first stop portion located at one of openings, with a first seal pad provided in an inner part of the screw cap. The rotating portion of the present invention is comprised of a rotating head with a central hollow and a connecting pipe. Another part of the rotating head connects to a pipe to provide a locking mechanism.

The connecting pipe passes through the screw cap to allow the rotating head to be covered within the screw cap. The surface area of the rotating head is in contact with the first seal pad in order to support the first stop portion of the screw cap. The screw tube has a second stop portion with external threading pattern, in which a second seal pad is provided on the second stop portion. A first pipe opening of the screw tube is screwed into the screw cap, and the screw cap is sealed with the second stop portion so that the first pipe opening of the screw tube securely encloses the hole of the rotating head. Thus, the hole of the rotating head is completely sealed off.

Both the forgoing general description and the following detailed description are exemplary and explanatory only and are not restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate components of the present invention and, together with the description, serve to explain the principles of the invention. In the drawings:

FIG. 1 is a schematic view of a conventional rotating joint utilized in an air compression pump and a pneumatic device;

FIG. 2 is a 3-D view of the conventional rotating joint;

FIG. 3 is a 3-D assembly view of a universal joint in accordance with a preferred example of the present invention;

FIG. 4 is a 3-D view of an assembled universal joint in accordance with the preferred example of the present invention;

FIG. 5 is a schematic view showing the universal joint of the present invention utilized in an air compression pump and a pneumatic device;

FIG. 6 demonstrates the universal joint in practice;

FIG. 7 is another example of showing the universal joint in practice.

FIG. 8 is a longitudinal cross-sectional view of the assembled universal joint as shown in FIG. 4.

### DESCRIPTION OF THE PREFERRED EMBODIMENTS

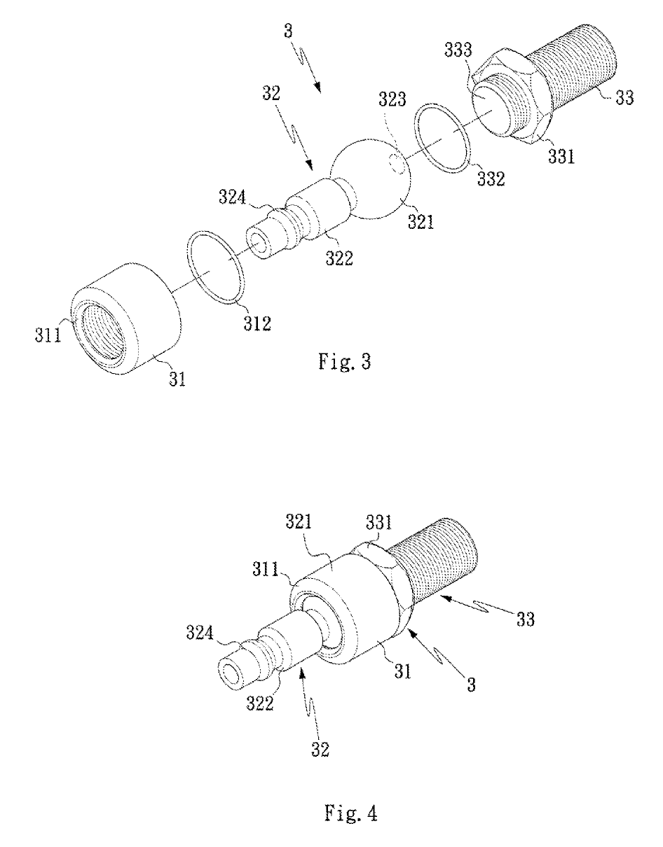

In FIGS. 3 and 4 there are 3-D assembly views of various components of a universal joint and an integrated universal joint in accordance with a preferred example of the present invention. The universal joint of the present invention is comprised of a screw cap 31, in which the screw cap has a first stop portion 311 locating at one of openings, and a first seal pad 312 provided in an inner part of the screw cap 31. Rotating portion 32 is comprised of rotating head 321 with a central hollow, and connecting pipe 322 connected to the rotating head 321, wherein the rotating head 321 and the connecting pipe 322 are connected and the rotating head 321 has a hole 323 provided on a upper half of the rotating head 321. The connecting pipe 322 and the rotating head 321 passes through a locking part 324, causing the rotating head 321 to be covered within screw cap 31. The surface area of the a lower half (which resembles a half-circle ball) of the rotating head 321 is in contact with the first seal pad 312 in order to support the first stop portion 311 of the screw cap 31.

The screw tube 33 is comprised of a second stop portion 331 with an external threading pattern, in which a second seal pad 332 is provided on the second stop portion 331. A first tube opening 333 of the screw tube 33 is screwed into the screw cap 31, and the screw cap 31 is sealed with the second stop portion 331 so that the first tube opening 333 of the screw tube 33 and the hole 323 of the rotating head 321 are securely closed off.

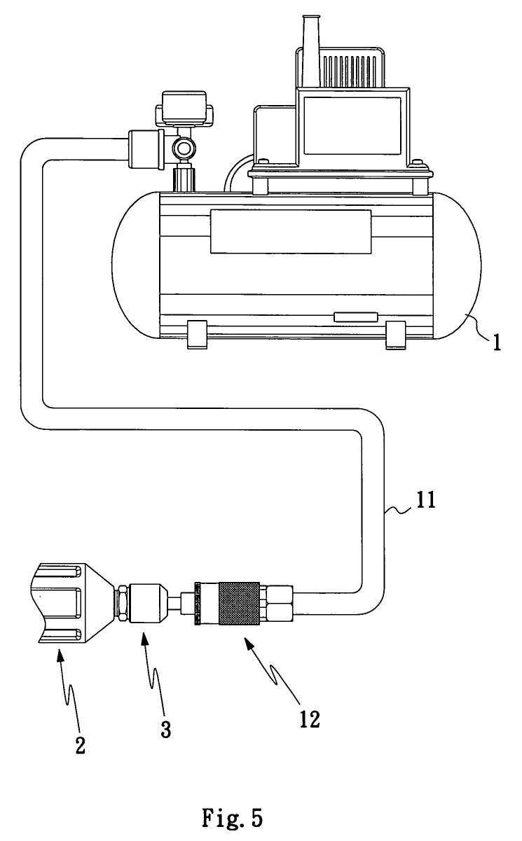

In FIG. 5, a schematic view shows a universal joint of the present invention utilized in an air compression pump and a pneumatic device. The air compression pump 1 is connected to an air pipe 11. One free end of air pipe 11 is comprised of valve joint 12 that is connected to a pneumatic device 2 which is capable of providing various functions. An end of the pneumatic device 2 can rotate toward the second stop portion 331 on the screw tube 33 of the universal joint 3 through a handle (not shown in the drawings). The screw tube 33 can then be locked into the corresponding end of the pneumatic device 2. The locking part 324 of the connecting pipe 322 is inserted tightly into the corresponding valve joint 12.

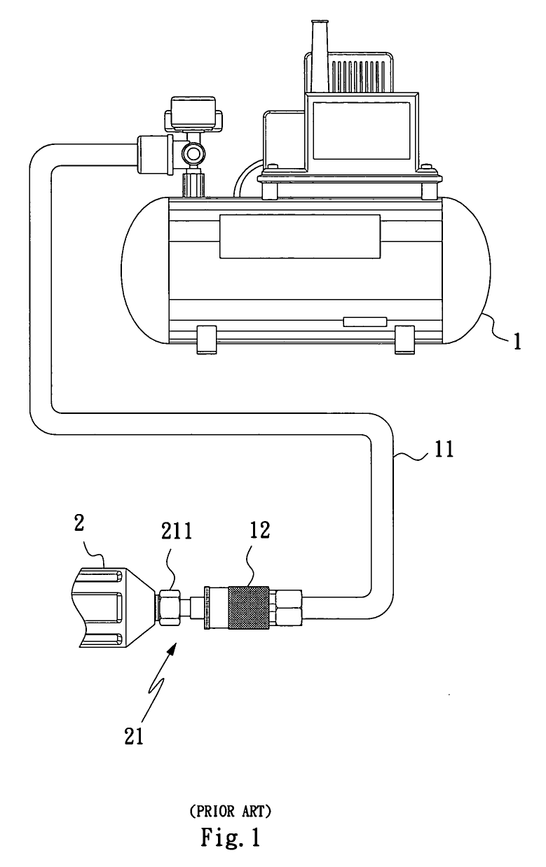

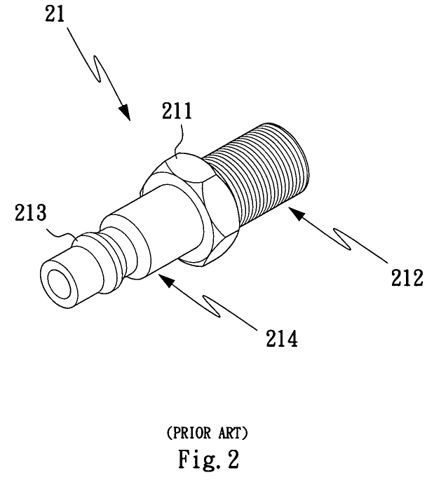

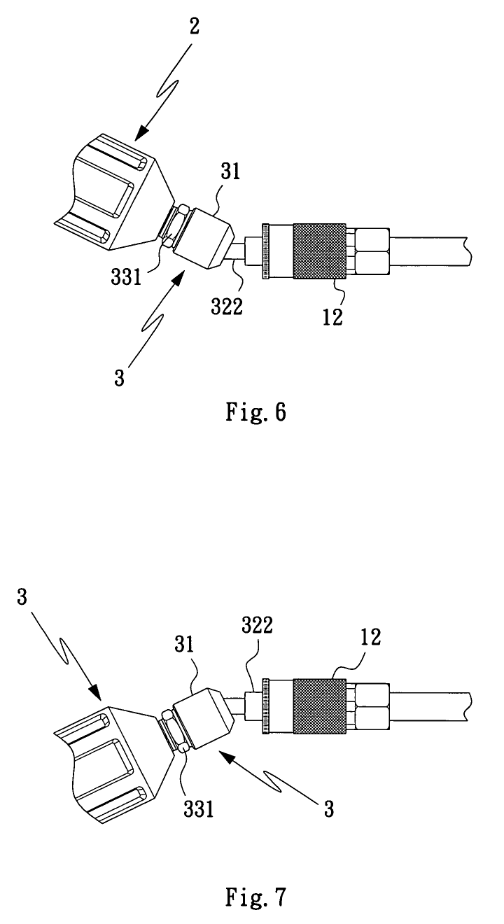

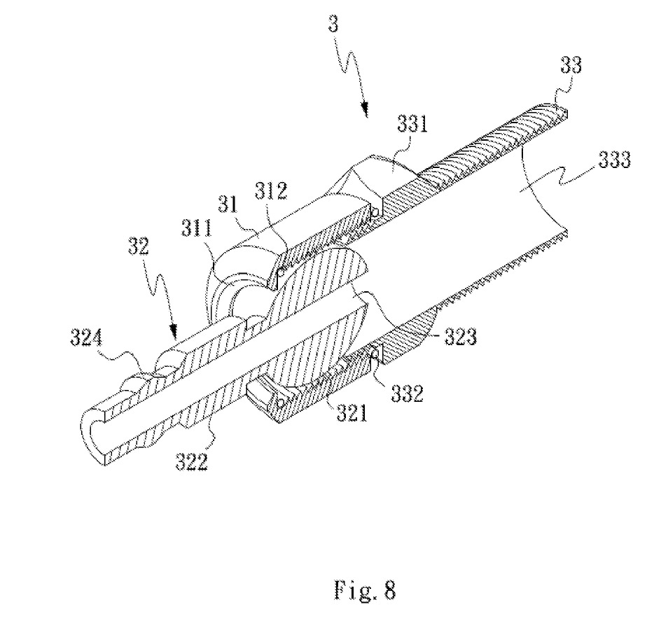

FIGS. 6 and 7 illustrate various examples of the universal joint utilized in practice in respect to FIGS. 1 and 2. When the user operates the pneumatic device 2 to disintegrate other devices, the operation angles of the pneumatic device 2 have to be adjusted according to various structures of the device. The end of the pneumatic device 2 can be rotated in an upward or downward direction with various angles through the rotating head 321 of the universal joint 3. Even in an environment with limited space, the pneumatic device 2 can still be utilized and bent in accordance with various angles to disintegrate components. As a result, the air pipe 11 of the air compression pump 1 can be connected to the pneumatic device 2 via the universal joint 3 to allow pneumatic device 2 to rotate in various directions without being restricted due to a connection to an air pipe. The pneumatic device 2 can move or rotate freely according to the needs of the operation.

Other embodiments of the invention will appear to those skilled in the art from consideration of the specification and practice of the invention disclosed herein. It is intended that the specification and examples to be considered are exemplary only, with a true scope of the invention being indicated by the following claims.

What is claimed is:

1. An universal joint, comprising:
a screw cap with two openings, having a first stop portion locating at one of openings, in which a first seal pad is provided in an inner part of the screw cap;
wherein the first stop portion has an inner diameter that is smaller than an inner diameter of the screw cap;
a rotating portion, having a rotating head with a central hollow and a connecting pipe connected to the rotating head, wherein the rotating head has a hole provided on a upper half-circle ball portion of the rotating head, the connecting pipe passes through the screw cap to allow the rotating head to be covered within the screw cap, and a surface area of a lower half-circle ball portion of the rotating head is in contact with the first seal pad in order to sealingly abut against the first stop portion of the screw cap via the first seal pad;
a screw tube, having a second stop portion with an outer diameter larger than an outer diameter of the screw tube, and said screw tube has an external threading pattern, wherein a second seal pad is provided on the second stop portion, the screw tube is screwed into the screw cap, and an end the screw cap is sealingly abutted against the second stop portion with the second seal pad disposed in between the end of the screw cap and the second stop portion, so that the first pipe opening of the screw tube and the hole of the upper half-circle ball are securely closed off, and the hole of the upper half-circle ball portion is completely sealed off; and
wherein the upper half-circle ball portion makes direct abutting contact with the screw tube, and said second seal pad does not make direct contact with any part of the rotating head.

2. The universal joint of claim 1, wherein an end of the connecting pipe has a locking part.
